(19) United States
(12) Patent Application Publication
(10) Pub. No.: US 2017/0291355 A1
(43) Pub. Date: Oct. 12, 2017

(54) Apparatus for 3D printing

(71) Applicant: Jing Zhang, Redondo Beach, CA (US)

(72) Inventor: Jing Zhang, Redondo Beach, CA (US)

(21) Appl. No.: 15/097,131

(22) Filed: Apr. 12, 2016

(51) Int. Cl. B29C 67/00; B33Y 30/00; B33Y 50/02; B33Y 10/00

(52) U.S. Cl. CPC B29C 67/007; B29C 67/0088; B29C 67/0092; B33Y 10/00; B33Y 30/00; B33Y 50/02; B29K 2105/0058

(57) ABSTRACT

A 3D printer for building 3-dimensional object using DLP technique, comprising a solidifiable material container, an irradiation component, a supporting component, a surface regulation component, and a control system. The 3D printer realizes large dimension and high speed printing by applying a flexible film over the surface of the photopolymer resin. The flexible film is separated from the solidified resin by peeling force.

### BACKGROUND

### 1. Field of the Invention

The present invention relates to a 3D printer. More particularly, the 3D printer is based on Digital Light Processing, and the photopolymer resin is cured at the top surface which is regulated by a plane film.

### 2. Discussion of the Related Art

Three dimensional (3D) printing is a process to form a three-dimension object. Different from traditional processes such as casting and cutting, 3D printing utilizes adding instead of removing materials to form the solid object which could have complex shape or geometry. This process is also known as additive manufacturing (AM), rapid prototyping or solid freeform fabrication. The machine to perform the process is called 3D printer.

Basically, 3D printing is achieved by building an object layer by layer from a particular material such as powered metal, droplets of plastic or any other appropriate material. Each of these layers is a thin slice cross-section of the eventual object which is generated by process similar to regular 2D printing in x and y dimensions. All layers are laid over successively in z dimension. With the thickness of these layers accumulated, a 3D object is formed.

There are number of different technologies developed based on different materials and the ways to form the layers, for example, Fused Deposition Modeling (FDM), Stereolithography (SLA), 3D Inkjet Powder (3DP), Selective Laser Sintering (SLS).

Digital Light Processing (DLP) is one of the well developed technologies recognized by its relatively high resolution and high speed. In this process, liquid solidifiable material (e.g., photopolymer resin) contained in a vat is exposed to visible light or UV light generated by DLP projector. The DLP projector displays the image of the 3D model onto the surface of the liquid solidifiable material. The exposed solidifiable material is solidified (or cured) to form a solid layer with desired pattern according to the image. Then the object is drawn away from the surface to let the liquid solidifiable material to fill in for next layer. By repeating the process a new layer is formed over previous layer until the 3D object is complete. Compare with SLA which uses a UV laser beam to cure the photopolymer resin spot by spot, DLP generates irradiation over its display area simultaneously to tremendously increase the curing speed. At the same time, benefiting from the projector technology, high resolution is available.

There are two ways to cure solidifiable material in DLP. One is called “top-down” in which new layers are formed at the top surface of the growing object. In this method, after each irradiation step the object under construction is submerged into the liquid solidifiable material, a new layer of solidifiable material is coated on top, and a new irradiation step takes place. During this process, it is necessary to reconstitute a layer of solidifiable material accurately because the thickness of the layer defined the resolution in z dimension. Obviously, this increases the processing time and complexity of the system. At the same time, the surface of each solidified layer must be smooth and planar in order to apply new irradiation step. Some techniques utilize of a paddle or a blade to sweep across the surface of the solidified layer to remove irregularities in the surface profile thereof. One of the reasons of the irregularities is surface tension because the top surface of the material is exposed to air. Again, this technique introduces additional processing time and mechanical complexity.

The other technique is called “bottom-up” in which new layers are formed at the bottom surface of the growing object. After each irradiation step the object under construction must be separated from the bottom plate of the vat. One big issue with such “bottom-up” techniques is that an accurately controlled force must be applied when separating the solidified layer from the bottom plate caused physical and chemical adhesive effect. Sometimes the required separation force is so great that it can deform or break the object.

Although DLP is already widely used and is available for desk-top printing, the application in commercial level is still limited. There are two disadvantages preventing DLP from involving in more area. First, the size of the object is limited; second, the process is still not fast enough.

Since the light source is DLP projector, the size of the object in x and y dimension is limited by the display area of the projector. But based on current projector performance, the display area can't be enlarged without sacrificing the resolution.

In bottom-up technique, larger size in x and y dimension means larger contact area between solidified material and the bottom of the vat, this will request larger separation force. However solidified material can only afford limited separation force to avoid deformation and which also restricts the size of the object.

Regarding processing speed, the operations of the surface of the object, such as sweeping the surface with a paddle, or separating the object form the bottom of the vat, consume a large amount of time.

Considering all these disadvantages mentioned above, it would be desirable to provide an apparatus and method in 3D printing to enlarge the object dimension, reduce the processing time, and simplify the mechanism.

### BRIEF SUMMARY OF THE INVENTION

The primary objective of the present invention is to develop a 3D printing apparatus and method applicable in commercial applications.

Another objective of the present invention is to develop a 3D printing apparatus and method to fabricate objects with large dimensions.

Another objective of the present invention is to develop a 3D printing apparatus and method to fabricate objects with high speed.

Another objective of the present invention is to develop a 3D printing apparatus with simplified mechanism.

The invention comprises the following, in whole or part:

An irradiation component, a solidifiable material container, a supporting component, a surface regulation component, and a control system.

The irradiation component comprises a projector to generate irritation over designated area on the top surface of the solidifiable material.

The solidifiable material container contains the liquid solidifiable material.

The supporting component provides a substrate for the solidifiable material to be solidified over it to form the object, and levels the solidified lay of the object at a desired position.

The surface regulation component comprises a regulation plane which provides a flat and smooth surface. This regulation plane is placed over the liquid solidifiable material therefore the top surface of the liquid solidifiable material is covered by the surface of the regulation plane. In this way a portion of the surface of the liquid solidifiable material is regulated in flat, the surface tension effect is eliminated. The surface regulation component also comprises a mechanism to peel the regulation plane from the solidified layer of the under building object.

The control system provides data to the projector for generating desired patterns, and controls the irradiation component, the supporting component, and the surface regulation plane to cooperate together.

For a more complete understanding of the present invention with its objectives and distinctive features and advantages, reference is now made to the following specification and to the accompanying drawings.

### BRIEF DESCRIPTION OF THE DRAWING(S)

FIG. 1 is a schematic view of a 3D printer according to the present embodiment of the invention.

FIG. 2 is a schematic view of the 3D printer according to the present embodiment of the invention.

FIG. 3 is a schematic view of the surface regulation component illustrating the peeling process according to the present embodiment of the invention.

FIG. 4 is a schematic view of the surface regulation component illustrating the peeling process according to an alternative embodiment of the invention.

FIGS. 5A and 5B illustrate a process for the projector to irradiate the working area.

FIGS. 6A and 6B illustrate an alternative process for the projector to irradiate the working area.

### DETAILED DESCRIPTION OF THE INVENTION

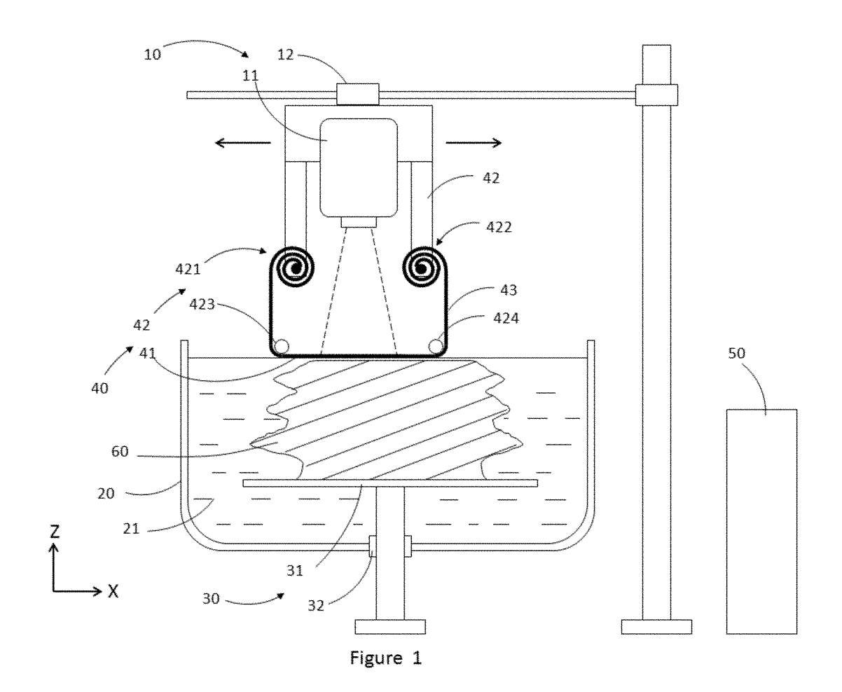

In accordance with a preferred embodiment, FIGS. 1 to 4 depict the machine as a presently embodiment, wherein machine comprises an irradiation component 10, a solidifiable material container 20, a supporting component 30, a surface regulation component 40, and a control system 50. A 3D object 60 is under building.

The irradiation component 10 comprises an irradiation source 11 which generates desired irradiation. In a preferred embodiment, the irradiation source 11 is a DLP projector 11 which generates visible light, UV light, or other forms of light. The irradiation component 10 also comprises a positioning mechanism 12. The positioning mechanism 12 is controlled by the control system 50 to move the projector 11 vertically (in z direction), and position the projector 11 with a predetermined height over the surface of the liquid solidifiable material 21. By adjusting the height, the resolution and display area of the projector 11 can be accurately controlled if the projector 11 is focused.

In a preferred embodiment of the present invention, the positioning mechanism 12 also moves the projector 11 horizontally (in x and y directions). In this manner, the irradiation area of a single projector can be extended, which means the size of the cross section of the object 60 will not be limited by the display area of the projector 11.

The solidifiable material container 20 is a vat with an opening at the top. The vat 20 contains solidifiable material 21 which can be solidified by the irradiation generated by the projector 11. In a preferred embodiment, the solidifiable material 21 is a liquid photopolymer resin. The solidifiable material container 20 has a predetermined size in x, y and z dimensions which is enough to merge the whole 3D object 60 within.

The supporting component 30 comprises an object platform 31 providing a substrate for the object 60 to be laid upon and supporting the under building object 60. The object platform 30 also comprises a supporting mechanism 32 which is mechanically coupled with the object platform 31. The supporting mechanism 32 moves the object platform 31 in z direction and can submerge the object 60 in the resin 21 and let a layer of liquid resin 21 with predetermined thickness fill over the top surface of the under building object 60.

The surface regulation component 40 comprises a regulation plane 41 which is transparent to the irradiation, and a supporting frame 42 which retains the regulation plane 41. The regulation plane 41 has a smooth and planar surface facing the resin 21 and is leveled in parallel with the surface of the resin 21. The supporting frame 42 places the regulation plane 41 on the surface of the resin 21 with no gap in between, therefore the regulation plane 41 is fully contacted with the surface of the resin 21. In this manner, the contact area of the resin 21 under the regulation plane 41 is regulated into a smooth plane. This eliminates the irregularities caused by surface tension effect, etc.

The object platform 31 of the supporting component 30 is under the regulation plane 41. Through the operation of the supporting mechanism 32, the top surface of the under building object 60 is placed beneath the regulation plane 41 with a predetermined distance so a thin layer of liquid resin is filled in between. The projector 11 of the irradiation component 10 is positioned above the regulation plane 41 by the positioning mechanism 12 and projects irradiation over the thin layer of the resin 21 through the regulation plane 41. This thin layer of liquid resin 21 will be cured by the irradiation on the top surface of the under building object 60 to form a new solidified layer.

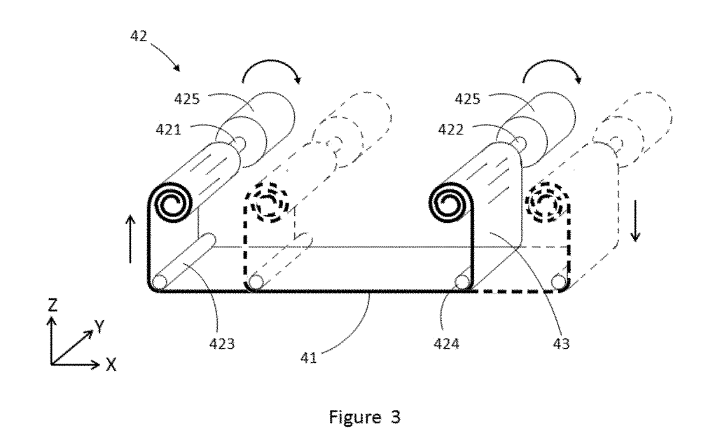

Referring to FIG. 1 and FIG. 3, in one embodiment of the present invention, the regulation plane 41 just covers the display area of the projector 11. The supporting frame 42 of the surface regulation component 40 is coupled with the positioning mechanism 12 of the irradiation component 10 in a manner that the projector 11 and the regulation plane 41 are retained together. In this way once the projector 11 is moved to a new position, the regulation plane 41 will be moved together to regulate the new surface area of the resin 21. The area of the regulation plane 41 may be smaller than the cross section of the object 60.

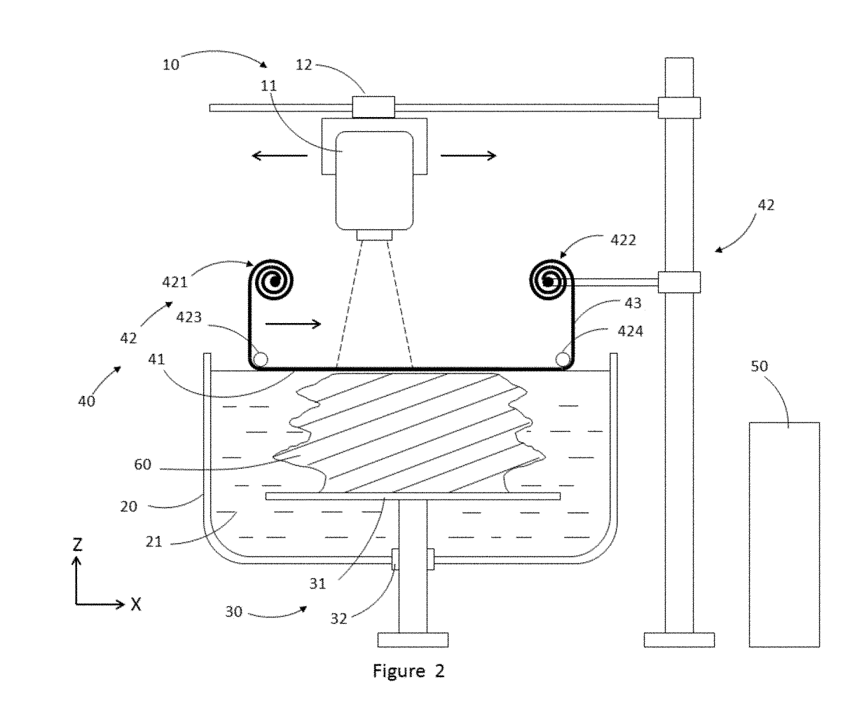

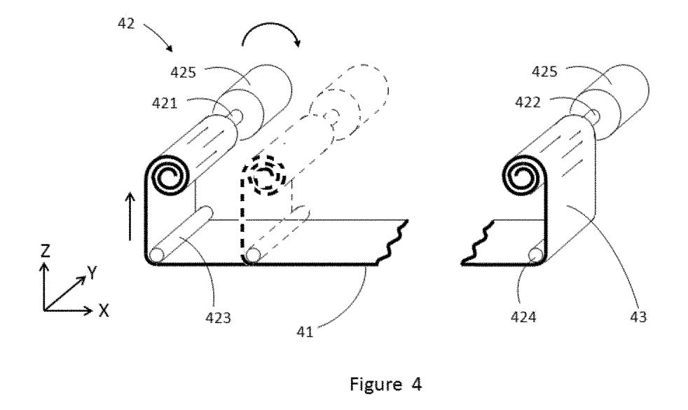

Referring to FIG. 2 and FIG. 4, in an alternative embodiment of the present invention, the regulation plane 41 covers the whole area of the cross-section of the object 60. This area is larger than the display area of the projector 11. In this way, during solidification, the regulation plane 41 remains still on the surface of the resin 21 while the projector 11 is moved over the regulation plane 41 to irradiate different area.

In a preferred embodiment of the present invention, the regulation plane 41 is formed by a transparent flexible film 43 which is shaped by the supporting frame 42. Preferably, the film 43 is an elongated band with the two ends rolled. Referring to FIGS. 1 to 4, the supporting frame 42 comprises a first holder 421 holding the first end of the film 43, and a second holder 422 holding the second end of the film 43. Both holders 421, 422 coupled with the two ends of the film band 43 by rolling the ends, and maintain a tension through the film 43. The supporting frame 42 also comprises a first shaft 423 and a second shaft 424 under the holders 421, 422. Both shafts 423, 424 are at the same level and are parallel to the surface of the liquid resin 21. The middle portion of the film 43 is pushed by the two shafts 423, 424 to form a flat plane as the regulation plane 41. In an embodiment of the present invention, the each holder comprises a motor 425 to rotate the film band 43. The motor 425 is controlled by the control system 50.

Once the liquid resin 21 is cured under the regulation plane 41, the new solidified layer may be adhered to the regulation plane 41 due to physical and chemical interaction. Therefore the regulation plane 41 needs to be lifted away from the solidified layer.

Referring to FIG. 4, during the lifting process, in one embodiment of the present invention, the position of the second holder 422 and the second shaft 424 are fixed with the vat 20, the first holder 421 and the first shaft 423 are moving horizontally towards the second holder 422 and the second shaft 424. At the same time, the first holder 421 is rolling the film 43 to maintain the tension of the film 43 and to apply peeling force.

Once the first and second shaft 423, 424 are closed together, the film 43 is totally separated from the solidified layer of the object 60. Then the object 60 will be lowered by the supporting component 30 to fill a new layer of resin 21. To regulate the new layer of resin 21, the first holder 421 and the first shaft 423 are moved away from the second holder 422 and second shaft 424. If the first holder 421 releases the rolled film 43, the old area of the film 43 will be reused as the regulation plane 41. If the second holder 422 releases the rolled film 43, new area of the film 43 will be used as the regulation plane 41.

In prior art of bottom-up technique, the object needs to be pulled from the bottom of the vat which is a rigid surface. Therefore the tensile force applied should overcome the adhesive force from the whole area of the solidified layer. But in the present invention, the flexible film 43 is peeled from the solidified layer. Therefore, only adhesive force from the edge of the film 43 under the shaft needs to be overcome. Compare with the whole area of the solidified layer, the area of the edge under the shaft is much less. Consequently, the required peeling force is much less.

In an alternative embodiment of the present invention, the supporting frame 42 moves the two holders 421, 422 and the two shafts 423, 424 together in x direction. During the movement, the two holders 421, 422 roll and unroll the film 43 respectively to maintain the tension, and remain the regulation plane 41 relatively still with the resin 21. For example, referring to FIG. 3, when the supporting frame 42 moves from left to right, the first holder 421 rolls the film 43 and peel the film 43 from the first shaft 423; the second holder 422 unrolls the film 43 and the second shaft 424 paves the film 43 over the new area of the resin 21 in right.

It is worth mentioning, once the film 43 is peeled, the same area of the film 43 can be reused. Or alternatively, used area will be rolled in by the first holder 421, and new area will be rolled out by the second holder 422, new area of the film 43 can be applied to form the regulation plan 41 for next layer of solidification.

The control system 50 is electrically connected with the irradiation component 10, the supporting component 30, and the surface regulation component 40. The control system 50 provides data to the irradiation component 10 for generating required display, at the same time controls the movement of the other components to perform 3D printing.

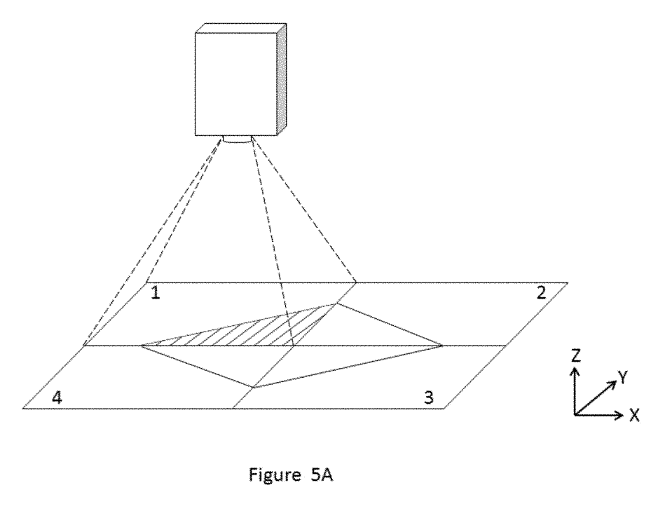

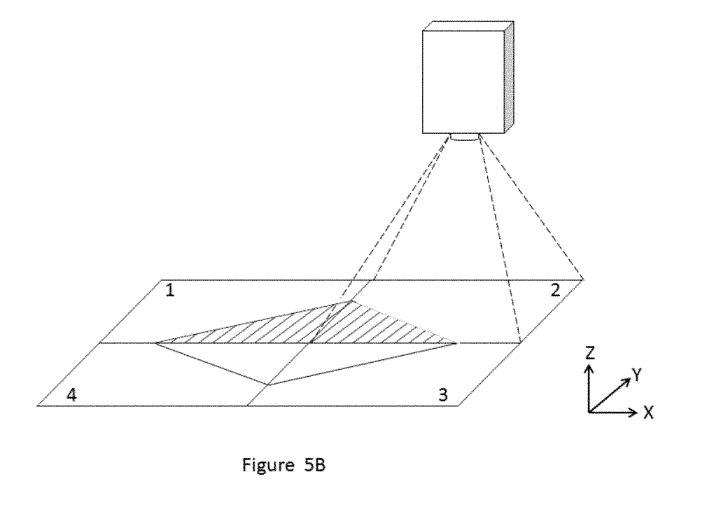

In one embodiment of the present invention, the dimension of the cross section of the object 60 is larger than the display area of the projector 11. In order to irradiate the entire area of the cross section of the object 60, the projector 11 is moved by the positioning mechanism 12 horizontally to irradiate different area. Referring to FIGS. 5A and 5B, the whole cross section of the object 60 is divided into multiple sections. Each section can be covered by the display of the projector 11. The projector 11 is moved over these sections individually and displays the relative images on the sections to cure the resin 21.

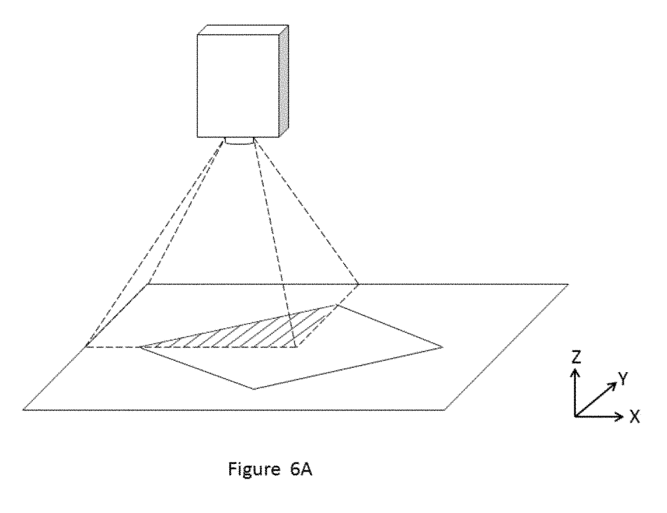

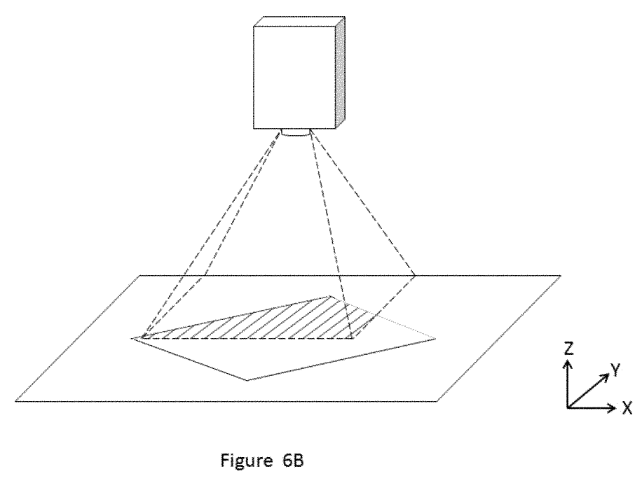

Referring to FIGS. 6A and 6B, in an alternative embodiment, the projector 11 is moved over the cross section of the projector 11 continuously like scanning the whole area. The positioning mechanism 12 utilizes step motor to make the movement. After each step of movement, the image displayed by the projector 11 will be shifted to make sure same image is displayed on the same area of the resin 21.

While the embodiments and alternatives of the invention have been shown and described, it will be apparent to one skilled in the art that various other changes and modifications can be made without departing from the spirit and scope of the invention.

What is claimed is:

1. A 3D printer for building a 3-dimensional object, comprising:
a solidifiable material container containing a solidifiable material;
an irradiation component comprising a projector to generate irradiation over a predetermined area of the surface of said solidifiable material for solidification;
a supporting component supporting said under building object and leveling the top surface of said object to have new layer of solidifiable material be solidified on said object,
a surface regulation component comprising a regulation plane transparent to said irradiation, and a supporting frame placing said regulation plane over said predetermined area of said surface of said solidifiable material to regulate said surface of said solidifiable material in flat, and
a control system providing data to said irradiation component to generate irradiation, and controlling movement of said irradiation component, said supporting component, and said surface regulation component.

2. The 3D printer, as recited in claim 1, wherein said regulation plane is a flexible film retained by said supporting frame.

3. The 3D printer, as recited in claim 2, wherein said film is in a form of an elongated film band with a first end and a second end; wherein said supporting frame comprises a first holder and a s second holder holding said first end and second end of said film band respectively to maintain a tension; wherein said supporting frame further comprises a first shaft and a second shaft pushing said film towards said surface of said solidifiable material to form said regulation plane.

4. The 3D printer, as recited in claim 3, wherein said regulation plane covers said whole predetermined area of the surface of said solidifiable material.

5. The 3D printer, as recited in claim 4, wherein said supporting frame horizontally moves said first shaft toward said second shaft, wherein said first holder pulls said film band upward at the same time to separate said film from said solidified surface of said object.

6. The 3D printer, as recited in claim 5, wherein said irradiation component comprises a positioning mechanism moving said projector horizontally over said regulation plane to irradiate said whole predetermined area of the surface of said solidifiable material.

7. The 3D printer, as recited in claim 5, wherein said first holder is rotatably coupled with said first end of said film band, wherein said first holder rolls said film to maintain said tension, and to pull said film upward.

8. The 3D printer, as recited in claim 7, wherein said second holder is rotatably coupled with said second end of said film band, wherein when said supporting frame moves said first shaft away from said second shaft to regulate a new layer of said solidifiable material, said second holder releases to provide new area of said film to form said regulation plane.

9. The 3D printer, as recited in claim 8, where said first holder comprises a first motor to rotate said first end of said film band; where said second holder comprises a second motor to rotate said second end of said film band.

10. The 3D printer, as recited in claim 3, wherein said regulation plane covers the irradiation area of said projector.

11. The 3D printer, as recited in claim 10, wherein said irradiation component comprises a positioning mechanism moving said projector horizontally over said regulation plane to irradiate said whole predetermined area of the surface of said solidifiable material.

12. The 3D printer, as recited in claim 11, wherein said supporting frame moves said regulation plane synthetically with said projector to cover said irradiation area of said projector.

13. The 3D printer, as recited in claim 12, wherein said first holder is rotatably coupled with said first end of said film band and said second holder is rotatably coupled with said second end of said film band to maintain said tension; wherein when said supporting frame moves said regulation plane continuously with said projector along the direction from said first shaft toward said second shaft, said first holder rolls said film in to pull said film upward, said second holder releases said film to form said regulation plane to regulate new area of said surface of said solidifiable material; wherein said regulation plane has no horizontal movement with said surface of said solidifiable material.

14. The 3D printer, as recited in claim 13, where said first holder comprises a first motor to rotate said first end of said film band; where said second holder comprises a second motor to rotate said second end of said film band.

15. A method of building a 3-dimensional object by DLP technology, comprising steps of:
(a) providing a transparent plane surface;
(b) placing said plane surface over a area of the top surface of a liquid solidifiable material to regulate said area into flat;
(c) solidifying said solidifiable material regulated by said plane surface though a projector;
(d) separating said plane surface from said solidified area;
(e) filling a new layer of liquid solidifiable material over said solidified area for a new layer of solidification.

16. The method, as recited in claim 15, wherein in step (a), said plane surface is made by a flexible film.

17. The method, as recited in claim 16, wherein in step (d), said plane surface is separated from solidified area by peeling said flexible film from one side to the other side.

18. The method, as recited in claim 17, wherein in step (c), further comprises a step of:
(c1) placing said projector to more than one position to irradiate more than one area of solidifiable material respectively.

19. The method, as recited in claim 17, wherein in step (c), further comprises a step of:
(c1) moving said projector continuously during irradiation to irradiate area of solidifiable material larger than the display area of said projector.
